(19) United States
(12) Patent Application Publication
(10) Pub. No.: US 2026/0259545 A1
(43) Pub. Date: Sep. 3, 2026

(54) METHOD TO OPTIMIZE THE NESTING OF TWO BLANKS WITHIN A LONGITUDINALLY EXTENDING FLAT STRIP

(71) Applicant: ArcelorMittal, Luxembourg (LU)

(72) Inventor: Alexandre BLAISE, Montataire (FR)

(21) Appl. No.: 18/871,500

(22) PCT Filed: Jun. 5, 2023
(86) PCT No.: PCT/IB2023/055774

§ 371 Date: Dec. 4, 2024

(30) Foreign Application Priority Data
Jun. 17, 2022 (WO) PCT/IB2022/055630
Jun. 17, 2022 (WO) PCT/IB2022/055634

(51) Int. Cl. G05B 19/4097

(52) U.S. Cl. CPC G05B 19/4097; G05B 2219/35162

(57) ABSTRACT

A computerized method to determine the best nesting of blanks in a strip in order to optimize the material usage and to determine the associated material usage. Solving the problem of material usage optimization involves at least three different variables (two rotation angles of the blanks and one transversal offset) and thus potentially involves optimizing the material usage function over a very large set of combinations. This leads to high computation times, which can be a serious hindrance to the implementation of the material usage optimization method. A computerized method to accelerate the computerized determination of the best blank nesting for material usage optimization and the associated material usage is also provided.

The present invention relates to the manufacturing of cut-out shapes and in particular to the manufacturing of shapes cut-out from a rectangular flat strip of material generally extending in a longitudinal direction.

### BACKGROUND

In many material manufacturing processes of generally flat materials, the continuous nature of the manufacturing process implies that the final manufactured product is in the form of a long strip generally extending in a longitudinal direction and having an elongated rectangular shape. This is the case for example in flat sheet metal production, such as flat steel products or flat aluminum products. It is also the case in the pulp and paper industry or when manufacturing fabrics and textiles. The aforementioned strip is often conditioned by winding it in a coil shape in order to store it and transport it efficiently.

One common way of using the material in the subsequent transformation processes is to cut out shapes having pre-determined contours from said strip. For example, one can cut out metal blanks in the case of a metallic strip or cut-outs of fabrics or textile in the fashion industry. In the case of a metallic strip, this operation is called blanking and the ensuing product is called a metal blank, i.e. a generally flat piece of metal having a pre-determined contour suitable for use in subsequent transformation processes. This operation can be performed for example by punching, jet water cutting, oxy cutting or laser cutting.

The term blank will be used hereafter for simplicity sake, but, as will be easily understood, the application field of the current invention is not limited to metallic materials.

### SUMMARY OF THE INVENTION

The pattern according to which the blanks are positioned in the strip, hereafter referred to as the nesting, affects the material usage of the blanking operation. The term “material usage” used in the current description and claims corresponds to the material component of the blanking operation and can include several different aspects listed below, the list is not comprehensive:
an environmental aspect: for example if the raw material production process emits CO₂, it will be interesting to optimize material usage during the blanking operation in order to reduce the overall CO₂ emissions,
a productivity aspect: optimizing the material usage means that less time spent producing the raw material is also optimized,
an industrial feasibility aspect: the blank nesting pattern determines the necessary width of the strip in the longitudinal direction, which can itself have an impact on the industrial feasibility of the raw material strip (very large width or very narrow width may not be feasible),
a cost aspect: optimizing material usage means less raw material is used and therefore less material cost is incurred.

In the current invention, the configuration is the following: a strip from which a first blank and a second blank are cut out, each blank having a predetermined contour. Each blank has the freedom to rotate around an axis perpendicular to the top and bottom surfaces of the strip and the second blank has the freedom to be positioned with a certain transversal offset compared to the first blank which is itself located close to an edge of the strip. The positioning of two successive blanks relative to one another in the longitudinal direction will determine a nesting pattern which is then repeated as long as the strip extends in the longitudinal direction. In the current invention, a cost function is associated to the positioning of the two blanks in a strip, said cost being a function of at least the orientation of each blank and the transversal offset between the blanks.

It is a first purpose of the current invention to provide a computer implemented method to determine the best nesting of the blanks in a strip in order to minimize the material usage. Solving the optimization problem involves three different variables (two rotation angles of the blanks and one transversal offset) and thus potentially involves optimizing the material usage function over a very large set of combinations. This leads to high computation times, which can be a serious hindrance to the implementation of the method. A second purpose of the current invention is therefore to provide a computer implemented method to accelerate the optimization method.

By providing a computer implemented method to minimize the material usage and by providing an acceleration method of said method the current invention allows to automatically determine the best nesting pattern of two blanks in a strip and the associated material usage in a rapid and error proof way. This increases the productivity of blanking design. In turn, this also allows to carry out the method on many different sets of blanks, allowing to investigate the nesting and material usage of a vast number of blank shapes in a minimal amount of time.

The present invention provides a computer implemented method for the nesting of two blanks A and B within a rectangular strip, said strip generally extending in a longitudinal direction X and having a transverse direction Y, said method comprising the following steps:
providing the 2-dimensional blank contours of A and B;
computing the value of a quantity Material(α, β, dy) for several values of α, β and dy to determine a minimum value, MinMaterial, of the quantity Material(α, β, dy), Material(α, β, dy) corresponding to the material usage obtained when nesting said blank contours in the rectangular strip, blank contour A being oriented with an angle α, blank contour B being oriented with an angle β and dy being the difference in transversal elevation between the lowest point of blank A and the lowest point of blank B, the minimum value of Material(α, β, dy);
outputting to a user the minimum value of Material(α, β, dy), noted MinMaterial, as well as the values αₒₚₜᵢₘₐₗ, βₒₚₜᵢₘₐₗ, dyₒₚₜᵢₘₐₗ such that Material(αₒₚₜᵢₘₐₗ, βₒₚₜᵢₘₐₗ, dyₒₚₜᵢₘₐₗ)=MinMaterial; and
positioning in the strip a first blank A with an angle αₒₚₜᵢₘₐₗ, a first blank B with an angle βₒₚₜᵢₘₐₗ and a transverse offset dyₒₚₜᵢₘₐₗ, a following blank A with an angle αₒₚₜᵢₘₐₗ and in transverse alignment of said first blank A and a following blank B with an angle βₒₚₜᵢₘₐₗ and a transverse offset dyₒₚₜᵢₘₐₗ and repeating the pattern along the strip.

### BRIEF DESCRIPTION OF THE DRAWINGS

The present invention will now be described in detail and illustrated by examples without introducing limitations, with reference to the appended figures:

FIG. 1 is an overview of the configuration of the nesting of two blanks in a strip,

FIGS. 2 and 3 are simplified graphic depictions of the accelerated cost minimization method,

FIGS. 4 and 5 represent particular embodiments of the present invention in which the blanking tolerance and the width tolerance of the strip are taken into consideration in the calculation of the cost,

FIGS. 6A to 7B are illustrations of a computation method for determining an optimal longitudinal spacing between blanks.

### DETAILED DESCRIPTION

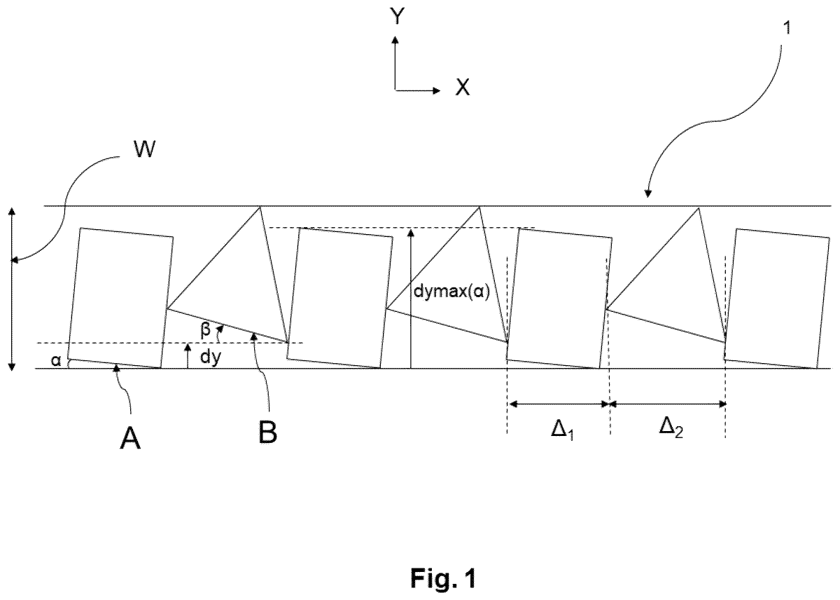

In the present invention, referring to FIG. 1, the longitudinal direction refers to the main direction in which a strip 1 extends and the transverse direction refers to the perpendicular direction of said longitudinal direction in the plane. The strip 1 further extends over a limited width between two parallel edges 2 and 3 in the transverse direction Y and extends over a width W in said direction.

The strip 1 has a top and a bottom side, also referred to as a top and bottom face. All appended figures are 2-dimensional top views on which only the top side is visible. The distance between the top and bottom faces is designated as the thickness of the strip. The thickness can be measured for example using a micrometer, the spindle and anvil of which are placed on the top and bottom faces.

In the following description and claims, the terms longitudinal and horizontal have the same meaning, the terms transverse and vertical have the same meaning. The terms “left” and “right” will be used in the subsequent description and claims, they respectively refer to a relative positioning further back and further along the longitudinal direction, i.e. along the direction marked by the “X” arrow in FIG. 1. The terms “up” (and “above”, “higher”, etc.), “down” (and “below’, “lower”, etc.) will be used in the subsequent description and claims, they respectively refer to a relative positioning further back and further along the transverse direction, i.e. along the direction marked by the “Y” arrow in FIG. 1.

Referring to FIG. 1, a first blank A having a first contour and a second blank B having a second contour are cut out from the strip 1.

Blank B is offset in the transverse direction from blank A by a transverse offset dy, which is defined as the difference in transversal elevation between the lowest point in the transverse direction of blank contour B and blank contour A. The transverse offset dy is expressed in mm.

Blank A and B respectively form an angle α and p with a given direction in the plane of strip 1. In the current invention, as a matter of convention, the angles α and p are defined in reference to the longitudinal direction. The angles α and p are expressed in degrees.

Referring to FIG. 1, Blank A has a height measured in the transverse direction dymax(a), which depends on the angle α. The maximum height value dymax is defined as the maximum value of dymax(a) for all possible values of a comprised between 0° and 360°.

A computer implemented method to determine the optimal (α, β, dy) for nesting blanks A and B in a strip and minimizing the ensuing material usage will now be described:
Step 1.1 consists of providing blank contours A and B.
Step 1.3 comprises computing the value of a quantity Material(α, β, dy) for several values of α, β and dy to determine a minimum value, MinMaterial, of the quantity Material(α, β, dy), Material(α, β, dy) corresponding to the material usage obtained when nesting said blank contours in the rectangular strip, blank contour A being oriented with an angle α, blank contour B being oriented with an angle β and dy being the difference in transversal elevation between the lowest point of blank A and the lowest point of blank B, the minimum value of Material(α, β, dy),
Step 1.4 consists of outputting to a user MinMaterial and the combination (αₒₚₜᵢₘₐₗ, βₒₚₜᵢₘₐₗ, dyₒₚₜᵢₘₐₗ) such that Material(αₒₚₜᵢₘₐₗ, βₒₚₜᵢₘₐₗ, dyₒₚₜᵢₘₐₗ)=MinMaterial.
Step 1.5 consists of positioning in the strip a first blank A with an angle αₒₚₜᵢₘₐₗ, a first blank B with an angle βₒₚₜᵢₘₐₗ and a transverse offset dyₒₚₜᵢₘₐₗ, a following (second) blank A with an angle αₒₚₜᵢₘₐₗ and in transverse alignment of said first blank A and a following (second) blank B with an angle βₒₚₜᵢₘₐₗ and a transverse offset dyₒₚₜᵢₘₐₗ and repeating the pattern along the strip, for instance as far as it extends longitudinally.

In step 1.3, the quantity Material(α, β, dy) corresponds preferably to the material usage obtained for an optimal longitudinal spacing between blank A and blank B, that is for a spacing that minimizes the material usage given that of a, p, and dy have fixed (and not necessarily optimal) values.

The longitudinal spacing between blank A and blank B is specified for instance by two pitches Δ₁ and Δ₂, Δ₁ being the distance in the longitudinal direction between the left extremity of an A blank and the left extremity of its right-hand neighboring B blank and Δ₂ being the distance between the left extremity of a B blank and the left extremity of its right-hand neighboring A blank.

The quantity Material(α, β, dy) then corresponds to the pitches Δ₁(α, β, dy) and Δ₂(α, β, dy) that minimize the material usage, given the values of α, β, and dy.

Δ₁(α, β, dy) may be determined iteratively, for the combination (α, β, dy) considered, by gradually moving blank B in the longitudinal direction towards blank A until it touches or almost touches it, for instance (and similarly for Δ₂). Δ₁(β, β, dy) and Δ₂(β, β, dy) may also be determined directly (instead of being iteratively optimized), using an explicit and fast calculation method described further below.

Anyhow, as presented above, in the method according to the present invention, the material usage minimization is carried on by splitting:
the optimization of the values of α, β and dy on one hand,
and the optimization of the longitudinal spacing Δ₁, Δ₂ on the other hand, the last one being carried on separately (that is, for each set (β, β, dy)).

Separating these two sub-optimizations one from another, instead of carrying on a global optimization in the 5-dimensional space of coordinates (α, β, dy, Δ₁, Δ₂), is beneficial. Indeed, for a given set (α, β, dy), i.e. once a value of α, of β and of dy is set, adjusting Δ₁ and Δ₂ (either iteratively, or directly), to minimize the material usage is convenient: it can achieved efficiently from a computing point of view. And, more generally, a split “3-dimensional plus 2-dimensional optimization” is easier to achieve than a complete, entangled 5-dimensional optimization, from a numerical point of view.

Besides, as above mentioned, once a value of α, of β and of dy is set, the optimal longitudinal spacing (that is, the computation of Δ₁(α, β, dy) and Δ₂(α, β, dy)) can be determine directly (thanks to a specific method), which further accelerate the nesting optimization.

The method for nesting two blanks herein described may comprise the following step 1.2: providing the material usage function Material(α, β, dy). This material usage function may take the form of a computer subprogram, routine or other function returning the value of Material(α, β, dy), given the values of a, p and dy.

In order to discretize the problem, an angular accuracy ε_{angle} expressed in angular degrees and a distance accuracy ε_{dy} expressed in mm are provided. For example, ε_{angle}=1° and ε_{dy}=1 mm. Step 1.3 then comprises computing MinMaterial as being the minimum value of all Material(α, β, dy) values overall the combinations Of (ε_{angle}*i, ε_{angle}*j, ε_{dy}*k), where i, j and k are integers comprised between 0 and respectively 360/ε_{angle}+1, 360/ε_{angle}+1 and dymax/ε_{dy}+1. Still, it may be noted that the detailed discretization could be different than in the above example: the discrete values of a, p, dy may belong to a lattice of values (of points) that is not necessarily rectangular (contrary to the example above), and the step between two distinct values may possibly be non-constant.

Anyhow, in the exemplary discretization scheme above, it may be noted that i, j and k do not necessarily take all possible integer values comprised between 0 and respectively 360/ε_{angle}+1, 360/ε_{angle}+1 and dymax/ε_{dy}+1. In other words, the quantity Material(α, β, dy) needs not to evaluated for all integers value comprised between 0 and respectively 360/ε_{angle}+1, 360/ε_{angle}+1 and dymax/ε_{dy}+1 to determine MinMaterial. In particular, in an accelerated method for executing step 1.3 that is presented below, the quantity Material(α, β, dy) is evaluated for only a part of the integers values comprised between 0 and respectively 360/ε_{angle}+1, 360/ε_{angle}+1 and dymax/ε_{dy}+1 (to avoid redundancies in the calculations).

In a particular embodiment, step 1.3 of the above described method further comprises the determination of pitches Δ₁(αₒₚₜᵢₘₐₗ, βₒₚₜᵢₘₐₗ, dyₒₚₜᵢₘₐₗ) and Δ₂(αₒₚₜᵢₘₐₗ, βₒₚₜᵢₘₐₗ, dyₒₚₜᵢₘₐₗ), such that Δ₁(αₒₚₜᵢₘₐₗ, βₒₚₜᵢₘₐₗ, dyₒₚₜᵢₘₐₗ) is the distance in the longitudinal direction between the left extremity of an A blank and the left extremity of its right-hand neighboring B blank, Δ₂(αₒₚₜᵢₘₐₗ, βₒₚₜᵢₘₐₗ, dyₒₚₜᵢₘₐₗ) is the distance between the left extremity of a B blank and the left extremity of its right-hand neighboring A blank.

In a particular embodiment, step 1.5 of the above described method further comprises the use of Δ₁(αₒₚₜᵢₘₐₗ, βₒₚₜᵢₘₐₗ, dyₒₚₜᵢₘₐₗ) and Δ₂(αₒₚₜᵢₘₐₗ, βₒₚₜᵢₘₐₗ, dyₒₚₜᵢₘₐₗ), such that step 1.5 consists of positioning in the strip a first blank A with an angle αₒₚₜᵢₘₐₗ, a first blank B with an angle βₒₚₜᵢₘₐₗ and a transverse offset dyₒₚₜᵢₘₐₗ and a longitudinal offset Δ₁(αₒₚₜᵢₘₐₗ, βₒₚₜᵢₘₐₗ, dyₒₚₜᵢₘₐₗ) compared to said first blank A, positioning the following blank A with an angle αₒₚₜᵢₘₐₗ in transversal alignment with said first blank A and with a longitudinal offset Δ₂(αₒₚₜᵢₘₐₗ, βₒₚₜᵢₘₐₗ, dyₒₚₜᵢₘₐₗ) towards said first blank B and repeating the pattern along the strip as far as it extends longitudinally.

In the rest of the following description, MinMaterial will also be referred to as the “real optimal” and (αₒₚₜᵢₘₐₗ, βₒₚₜᵢₘₐₗ, dyₒₚₜᵢₘₐₗ) as the “real optimal combination”.

If for example ε_{angle}=1°, ε_{dy}=1 mm and dymax is for example 500 mm, which is a typical value for the dimensions of a steel blank for example, the number of possible (α, β, dy) combinations over which the calculations need to be performed will be 360*360*500=64.8 million. Performing such a large number of calculations is costly in terms of computer usage and is a hindrance to the implementation of the method, especially in a situation in which several blank shapes need to be taken into account.

The inventors have found that calculating Material (α, β, dy) over the entire range of possible (α, β, dy) combinations in step 1.3 leads to many redundant calculations on combinations which are far from the best combination. Taking this into account, the inventors have developed a method to accelerate step 1.3 of the above described optimization method by performing several iterations of Material(α, β, dy) calculations on smaller numbers of possible (α, β, dy) combinations. At each iteration, the (α, β, dy) combinations having the lowest material usage are selected and each subsequent iteration is performed using neighboring points of the selected points. Overall, this allows to greatly diminish the number of (α, β, dy) combinations over which the function Material(α, β, dy) needs to be calculated. In the subsequent description and claims, this method will be designated as the accelerated method.

The number of iterations of the accelerated method is denoted by N, which is an integer equal to or greater than 2.

The accelerated method comprises the following steps:
Step 2.1: Selecting the (α, β, dy) combinations having the lowest Material(α, β, dy) values out of only part of the possible combinations (α, β, dy) of step 1.3 of claim 1,
Step 2.2: Repeating the following iterations for k=1 to N-1: Selecting the (α, β, dy) combinations having the lowest Material(α, β, dy) values out of the (α, β, dy) combinations selected at the previous step and at least part of their neighboring (α, β, dy) combinations, wherein a neighboring combination to (α, β, dy) is a combination (α+X*uₖ*ε_{angle}, β+Y*vₖ*ε_{angle}, dy+Z*wₖ*ε_{dy}), wherein X, Y and Z can each take on the values −1, 0 or +1, wherein uₖ, vₖ and wₖ are integers equal to or greater than 2 and wherein uₖ<uₖ−1, vₖ<vₖ−1 and wₖ<wₖ−1,
Step 2.3: Determining the accelerated minimum material usage MinMaterialAcc as being the minimum value of Material(α, β, dy) out of the (α, β, dy) combinations selected at the previous step and at least part of their neighboring (α, β, dy) combinations (α+X*u_{N}*ε_{angle}, β+Y*v_{N}*ε_{angle}, dy+Z*w_{N}*ε_{dy}), wherein X, Y and Z can each take on the values −1, 0 or +1, wherein u_{N}, v_{N} and w_{N} are integers equal to or greater than 1 and wherein u_{N}<u_{N-1}, v_{N}<v_{N-1} and w_{N}<w_{N-1},
Step 2.4: Outputting to a user said accelerated minimum material usage MinMaterialAcc as well as the values α_{optimal_aco}, β_{optimal_acc}, dy_{optimal_acc} such that Material(α_{optimal_acc}, β_{optimal_acc}, dy_{optimal_acc})=MinMaterialAcc.

Thanks to the above described accelerated method, the number of Material(α, β, dy) calculations can be greatly reduced, leading to a much lower computation time. One may note that the method for accelerating step 1.3, based on gradually selecting points and then exploring their neighborhood more finely, can be implemented differently than in the above example. For instance, the neighboring of each selected point may correspond to a spherical, or almost spherical area around that point, instead of corresponding to the paralepidid (rectangular like) neighboring area of the above example.

Choosing the reduced set of possible combinations (α, β, dy) in step 2.1 is a matter of compromise. Indeed, if the number of possible combinations chosen is very large, the accelerated method will be slower. On the other hand, if the number of possible combinations is very low, there is a risk that the final result MinMaterialAcc will be far from the real optimal result of the non-accelerated method. Indeed, the accelerated method relies on testing a first set of points and then testing their neighboring points with ever smaller distances between the points as the iterations progress. If the initial set of combinations is too small with very large spaces in between two combinations, there is a risk that the real optimal combination will lie far from the initial set of combinations and will never be reached when subsequently exploring the neighboring points.

In a particular embodiment, the possible (α, β, dy) combinations of step 2.1 are (ε_{angle}*C*i, ε_{angle}*D*jε_{dy}*E*m) combinations wherein C, D and E are fixed integers strictly greater than 1 and wherein i, j and m are integers taking on all the integer values between 0 and respectively 360/(ε_{angle}*C)+1, 360/(ε_{angle}*D)+1 and dymax/(ε_{dy}*E)+1. In other words, the initial set of combinations is a regular grid within the space of all possible (α, β, dy) combinations. Advantageously, this allows to optimize the space in between the initial (α, β, dy) combinations, which makes it less likely to miss the real optimal combination when using the accelerated method.

In a particular embodiment, the accelerated method further comprises an initial step of providing a tolerance threshold T % strictly greater than 0% and strictly smaller than 100%. The selection process of iterative step 2.2 is then performed by selecting the T % (α, β, dy) combinations having the lowest Material(α, β, dy) value out of the (α, β, dy) combinations selected at the previous step and at least part of their neighboring (α, β, dy) combinations. Advantageously, this allows to implement a reproducible method for each selection step—it is also well adapted for encoding in the form of a computer program. Choosing the relevance threshold is also a matter of compromise. The higher T % is, the more points will be carried over to the following step and thus more calculations will be involved at the following step. But, on the other hand, if the relevance threshold T % is too low, there is a risk to miss the real optimal combination when applying the acceleration method.

In a particular embodiment, iterative step 2.2 of the accelerated method is characterized by the fact that uₖ=uₖ₋₁/2, vₖ=vₖ₋₁/2 and wk=wₖ₋₁/2. In other words, at each iteration the distance between the neighboring points and the selected points of the previous iteration is twice as small as during the previous iteration. Advantageously, this allows to obtain a very good compromise between the need to widely investigate the possible candidate combinations in the first iterations and the need to fine tune the set of possible candidates with a very high resolution in the last iterations.

In a particular embodiment, the accelerated method is further characterized by the fact that all the neighboring (α, β, dy) combinations of the (α, β, dy) combinations selected during the previous step are used, i.e. all combinations (α+X*uₖ*ε_{angle}, β+Y*vₖ*ε_{angle}, dy+Z*wₖ*ε_{dy}), wherein X, Y and Z take on all of the values −1, 0 and +1 are used at steps 2.2 and 2.3. Advantageously, this allows to systematically check all the neighboring combinations of the combinations selected at the previous step, thereby minimizing the risk to miss the real optimal combination.

In a particular embodiment, the accelerated method is further characterized by the fact that u_{N}=1, v_{N}=1 and w_{N}=1. In other words, the neighboring points of step 2.3 of the accelerated method are situated right next to the selected points of the last iteration of step 2.2, at a distance of respectively ε_{angle}, ε_{angle} and ε_{dy}, for a, p and dy. Advantageously, this allows to investigate possible candidates with a very fine mesh at the last iteration, thereby minimizing the risk to miss the optimal result.

In the case of nesting steel blanks of different shapes in a strip of steel, the inventors have performed several trials using a combination of the above described embodiments and different N and T % values applied to different examples of industrial blank contours A and B in order to determine the best N and T % values allowing a very high computation speed and making sure that the real optimal combination is found.

The inventors have found that it was possible to reach the real optimal values using the following particular combination of the above described embodiments:
ε_{angle}=1°, ε_{dy}=1 mm and N=5,
the accelerated method further comprises an initial step of providing a tolerance threshold T % of 1%. The selection process of iterative step 2.2 is then performed by selecting the (α, β, dy) combinations having the 1% lowest Material(α, β, dy) value out of the (α, β, dy) combinations selected at the previous step and at least part of their neighboring (α, β, dy) combinations,
the possible (α, β, dy) combinations of step 2.1 are (ε_{angle}*C*i, ε_{angle}*D *j, ε_{dy}*E*m) combinations and C=D=E=2^{N-1}
uₖ=uₖ₋₁/2, vₖ=vₖ₋₁/2 and wk=wₖ₋₁/2,
u_{N}=1, v_{N}=1 and w_{N}=1 (this is actually a consequence of the two above listed embodiments),
all the neighboring (α, β, dy) combinations of the (α, β, dy) combination selected during the previous step are used, i.e. all combinations (α+X*uₖ*ε_{angle}, β+Y*vₖ*ε_{angle}, dy+Z*wₖ*ε_{dy}), wherein X, Y and Z take on all of the values −1, 0 and +1 are used at steps 2.2 and 2.3.

The trials were performed using 18 different configurations of blank contour A and B. The number of points given in the second column reflects the sum of the number of vertices of blanks A and B when representing the blank contours numerically in the form of a set of vertices joined by straight edges. This number is an indication of the complexity of the shape of the blanks and thus of the amount of time that Material(α, β, dy) will take to compute for a given combination. The higher the number of points, the longer the basic calculation of Material(α, β, dy) and therefore the longer it will take to find MinMaterialAcc. The third column gives the result of MmnMaterial (the real optimal of the non-accelerated method, labelled here “MinMat”). The MinMaterialAcc results (labelled in the table “MinMatAcc”) are given for each tested T % value alongside the time necessary to perform the accelerated method, the calculations were performed on a standard portable computer. As can be seen, the calculation time for T %=1% remain very reasonable and the MinMaterialAcc value is in all cases the real optimal MinMaterial. When decreasing the tolerance threshold T %, the computation time is decreased because less possible combinations are selected at each iteration in step 2.2. However, the resulting MinMaterialAcc is not always the real optimal MinMaterial. The cases deviating from the real optimal are highlighted in grey in the table. The inventors have found that for N=5, in the configuration where the method is applied to typical steel blanks for manufacturing for example automotive parts, T %=1% is a very good compromise between computation time and reaching the best solution to the optimization problem.

In a particular embodiment, each calculated Material(α, β, dy) value for a given (α, β, dy) combination is stored in a way that it can be retrieved anytime that said calculation is necessary. For example, each calculated result is stored in a hash table in which the index key is a label naming a, p, dy, such as for example the string “α_β_dy”. Advantageously, this allows to avoid calculating more than once the material usage of a given combination, thereby reducing the overall computation time.

In a particular embodiment, a function dymax(a) is defined as being the height measured in the transverse direction of blank A when A is oriented with an angle α. For a given value of α, dymax(a) corresponds to the maximum value of dy above which blanks A and B cannot possibly touch each other anymore. Nesting blanks A and B with dy>dymax(a) is usually not optimal in terms of material usage, especially is the amount of scrap generated by the blanking operation is an important factor. In a particular embodiment, the accelerated method is conducted using only combinations having dy<dymax(α). Advantageously, this avoids performing potentially useless calculations and thus lowers the calculation time without risk of missing the real optimal combination.

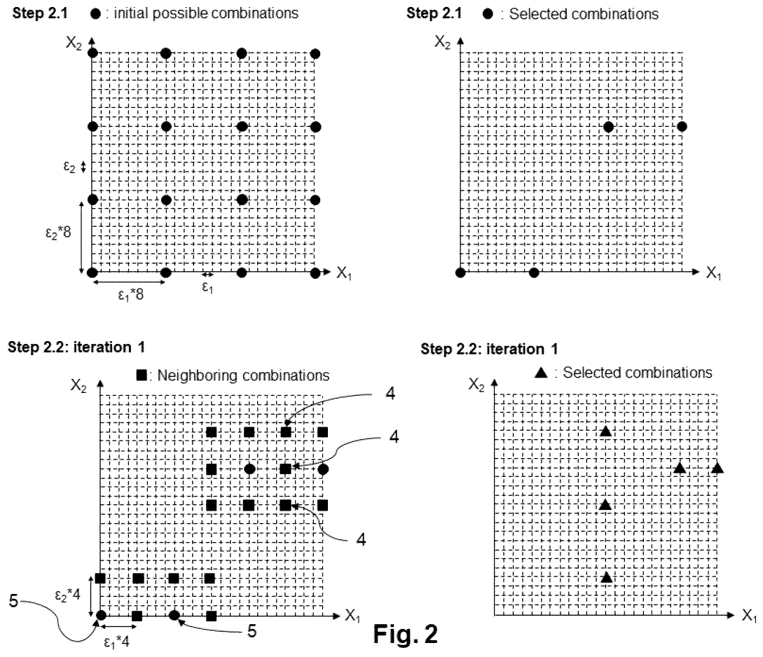

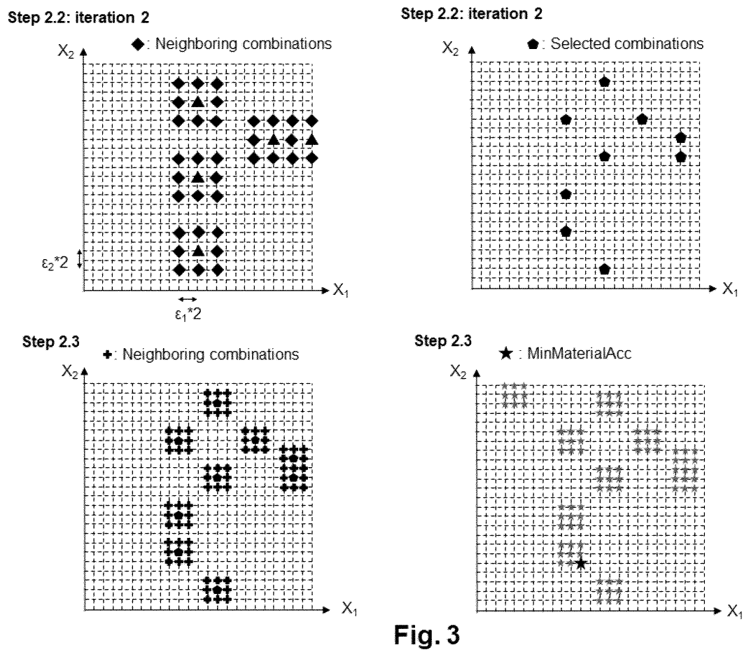

FIGS. 2 and 3 are simplified graphic depictions of a particular embodiment of the accelerated method using a case in which only two variables are taken into account. This simplification allows to represent the method in a 2-dimensional space instead of the 3-dimensional space necessary for the α, β, dy combinations and is done for clarity sake. The problem space is represented with an X₁, X₂ set of cartesian coordinates. The accuracies of the two variables are ε₁ and ε₂.

In FIGS. 2 and 3, the number of iterations that was chosen is N=4. The relevance threshold T % is 25%. The corresponding iteration number and step within the iteration is indicated on top of each graph.

Referring to FIG. 2 upper left-hand side, in this particular example the initial possible combinations for step 2.1 are of the type (ε₁*C*i, ε₂*D*j) combinations and C=D=2^{N-1}=2⁴⁻¹=8. Since there are 16 initial combinations, the total number of combinations selected in the upper right-hand side graph, representing the end of step 2.1, is 25%*16=4 combinations.

The depicted example is a case in which uₖ=uₖ₋₁/2 and vₖ=vₖ₋₁/2. Referring to FIG. 2, lower left-hand side, the neighboring combinations at step 2.1 iteration 1 are located at a distance of ε₁*8/2=ε₁*4 in the X₁ direction and ε₂*4 in the X₂ direction of the combinations selected at the end of step 2.1. These graphs also show a situation which can occur when generating the neighboring combinations, namely the fact that some selected points can have common neighbors. This is the case for example of the points indicated by the reference label 4. In a particular embodiment, the accelerated method will be programmed in such a way that the material usage of these points is not calculated twice, as previously explained (for example through the use of a hash table to associate material usage results to their combination).

Another situation that can arise is illustrated by combinations bearing the reference label 5: these combinations are located on an edge of the space defined by all combinations in the X₁, X₂ coordinate system and thus have a more limited number of neighbors.

Referring to FIG. 2 lower right-hand side, the 25% lowest material usage points are selected out of a total of 20 points, 20*25%=5 points are selected in total.

Referring to FIG. 3 upper left-hand side, at step 2.2 iteration 2 the distance between neighboring points is down to ε₁*4/2=ε₁*2 and ε₂*2. This leads to a total of 39 previously selected combinations and neighboring combinations. Referring to FIG. 3 upper right-hand side, out of these 39 points the 25%*39=9 combinations having lowest material usage are selected.

Referring to FIG. 3 lower left-hand side, depicting step 2.3, the distance between neighbors is ε₁*2/2=ε₁ and ε₂, i.e. this is a case when u_{N}=v_{N}=1. This yields 78 total combinations out of which the minimum material usage value is MinMaterialAcc and allows to determine also the optimal combination (see FIG. 3 lower right-hand side).

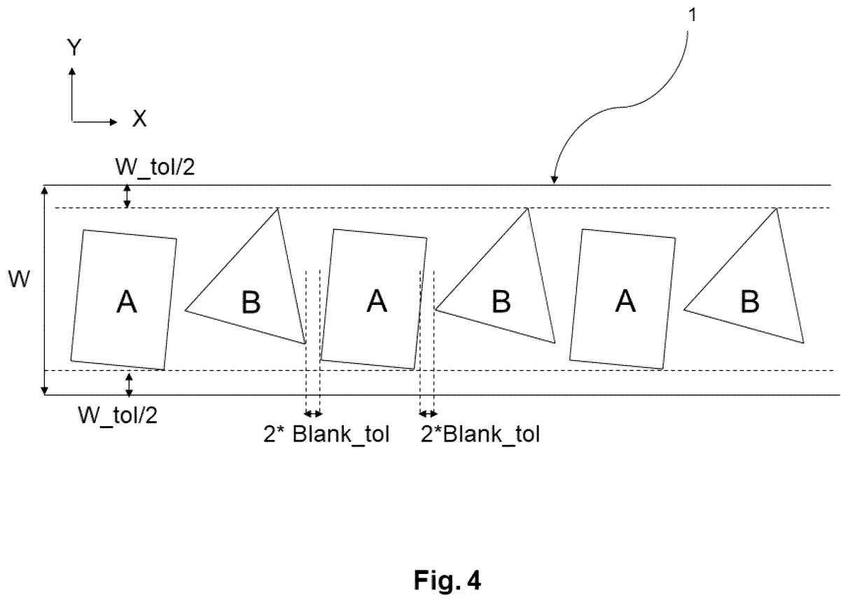

To summarize, the accelerated method in the simplified graphic depiction of FIGS. 3 and 4 will necessitate the calculation of the material usage function over the following number of combinations:
Step 2.1: 16 combinations.
Step 2.2 iteration 1: 20−4=16 combinations (number of neighboring combinations-number of previously selected combinations—the material usage of previously selected combinations has already been calculated and stored at the previous step).
Step 2.2 iteration 2: 39-5=34 combinations.
Step 2.3: 78-9=69 combinations.

Overall, the accelerated method involves calculating the material usage function over 16+16+34+69=135 combinations. The total number of possible combinations when using a non-accelerated method is 26*26=676. Thus, in this simplified case, involving one less variable than the actual 3-dimensional problem of the present invention and a small number of possible values of the variables (26 in the simplified example instead of 360 for angle values for example when the angular accuracy is 1°), the accelerated method already affords a very significant 5-fold diminution of the amounts of calculations to be performed.

In a particular embodiment, the material usage function Material(α, β, dy) is related to the cost of the blanking operation. Said cost can be for example a monetary cost or an environmental cost (CO₂ emissions) or a combination of both. The material usage value takes into account the cost of the material, the scrap ratio and the cost of scrap if a scrap buy-back market is available—the following elements are employed to calculate the material usage of a given (α, β, dy) combination, in this embodiment:
the pitch Δ₁(α, β, dy) mentioned previously,
the pitch Δ₂(α, β, dy) mentioned previously,
A scrap ratio Scrap(α, β, dy) defined as the ratio between the scrap generated by the blanking process to the total amount of strip material used,
a strip thickness t, defined above as the distance between the top side and the bottom side of the strip, t is for example expressed in mm,
a material cost Cost_material for one unit of weight, for example expressed in currency/ton,
in the case in which the scrap material can be bought back, for example this is the case in the steel industry where the scrap is re-melted, a Scrap cost Cost_Scrap per unit of weight, for example expressed in currency/ton,
a material density p, defined as the ratio between the weight and the volume of the material, p is usually expressed in kg/m³

Material(α, β, dy) can then be computed using the following formula:

$$M\_Sec = ρ * t * W * ( {Δ}_{1} ( α , β , dy ) + {Δ}_{2} ( α , β , dy ) )$$

$$Material ( α , β , dy ) = Cost\_material * M\_Sec - Cost\_scrap * \% Scrap ( α , β , dy ) * M\_sec$$

In a particular embodiment, the material cost Cost_material depends on the width of the strip W and is in fact provided in the form of a database Cost_database, comprising a set of p elements (Width_rangeⱼ, Cost_materialᵢ), p being an integer equal to or higher than 2 and j being an integer comprised between 1 and p, wherein Width_rangeⱼ is a width range having a minimum and maximum strip width value and Cost_materialᵢ is the material cost for one unit of weight when the width of the strip W is comprised within Width_rangeⱼ.

Variable costs according to the strip width can occur when the industrial cost of producing a strip is indeed dependent on the width. For example, the industrial cost can increase with the width if said width increase is associated with a lower productivity. For example, the material cost can increase with the width if large width material can only be produced in a determined industrial facility, entailing higher logistic costs.

As mentioned earlier, pitches Δ₁(α, β, dy) and Δ₂(α, β, dy) correspond here to optimal pitches between successive blanks, enabling to minimize the material usage (given the value of α, of β, and of dy). These pitches are preferably computed using the direct calculation method below, suitable for any polygonal-shape blank (that is for any blank whose contour comprises of straight edges):
positioning blank A in the X, Y coordinate system so that the furthest left point of blank A is located at X=0 and so that the lowest point of blank A is located at Y=0 and blank B is positioned so that the furthest left point of blank B is located at X=0 and the lowest point of blank B is located at Y=dy,
Providing a numerical representation of the contours of blank A and blank B in said X, Y coordinate system consisting of discrete sets of vertices {A₁, . . . , A_{P}} and {B₁, . . . , B_{q}}, p and q being integers greater than or equal to 3, said vertices being joined by straight edges,
Computing for each vertex Aᵢ the distance dAᵢA being defined as the difference between the largest X value taken by the contour of blank A and the smallest X value taken by the contour of blank A at the Y value of vertex Aᵢ and calculating the largest inner transverse distance dAA defined as the maximum value of all dAᵢA,
Computing for each vertex Bᵢ the distance dBᵢB being defined as the difference between the largest X value taken by the contour of blank B and the smallest X value taken by the contour of blank B at the Y value of vertex Bᵢ and calculating the largest inner transverse distance dBB defined as the maximum value of all dBᵢB,
Computing for each vertex Aᵢ located at a Y value for which at least one point of the contour of blank B is present the oriented distances dAᵢB and dBAᵢ defined respectively as the difference between the largest X value taken by the contour of blank B and the smallest X value taken by the contour of blank A at the Y value of vertex A and as the difference between the largest X value taken by the contour of blank A and the smallest X value taken by the contour of blank B at the Y value of vertex Aᵢ,
Computing for each vertex Bᵢ located at a Y value for which at least one point of the contour of blank A is present the oriented distances dABᵢ and dBᵢA defined respectively as the difference between the largest X value taken by the contour of blank B and the smallest X value taken by the contour of blank A at the Y value of vertex Bᵢ and as the difference between the largest X value taken by the contour of blank A and the smallest X value taken by the contour of blank B at the Y value of vertex Bᵢ,
Computing the oriented distance dAB defined as the maximum value of all dAᵢB and dABᵢ values, and computing the oriented distance dBA defined as the maximum value of all dBᵢA and dBAᵢ values,
Δ₁ being defined as the pitch in the longitudinal direction between the left extremity of an A blank and the left extremity of its right-hand neighboring B blank, Setting Δ₁ to the value dBA,
Δ₂ being defined as the pitch between the left extremity of a B blank and the left extremity of its right-hand neighboring A blank, setting Δ₂ to dBA if dAB+dBA≥dAA and dAB+dBA≥dBB, setting Δ₂ to dAA−dBA if dAB+dBA<dAA and dAA≥dBB, setting Δ₂ to dBB−dBA if dAB+dBA<dBB and dBB>dAA.

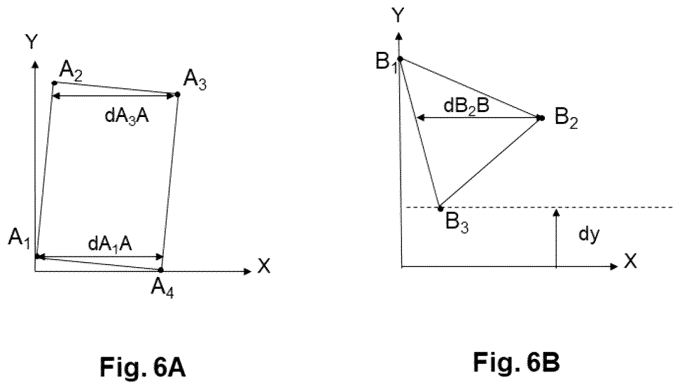

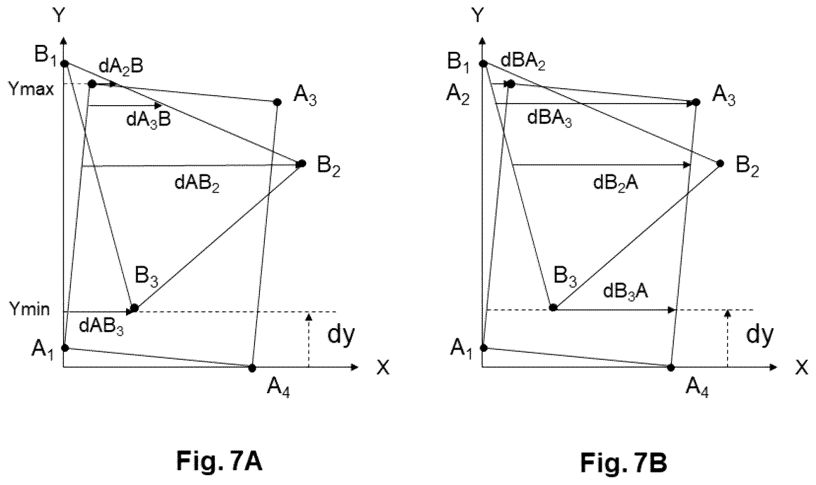

This way to determine dAA, dAB, dBB and dBB, and then Δ₁ and Δ₂, is illustrated in FIGS. 6A to 7B for a simple example in which blank A is rectangular and blank B triangular (like in FIG. 1). The blank contours of A and B are represented respectively by vertices A₁, A₂, A₃, A₄ and B₁, B₂, B₃ joined by straight edges. Each vertex Aᵢ is identified by its coordinates (XAᵢ, YAᵢ) and each vertex Bᵢ is identified by its coordinates (XBᵢ, YBᵢ).

In the case of FIG. 6A for example, dA₂A and dA₄A are equal to 0, while dA₃A and dA₁A have equal values, thus dAA=dA₃A=dA₁A. While for FIG. 6B, dBB=dB₂B.

In the case of FIG. 7A, which represents the oriented vectors corresponding to the values dAᵢB and dABᵢ, dAB is equal to dAB₂. In the case of FIG. 7B, which represents the oriented vectors corresponding to the values dBᵢA and dBAᵢ, dBA will be equal to dBA₃.

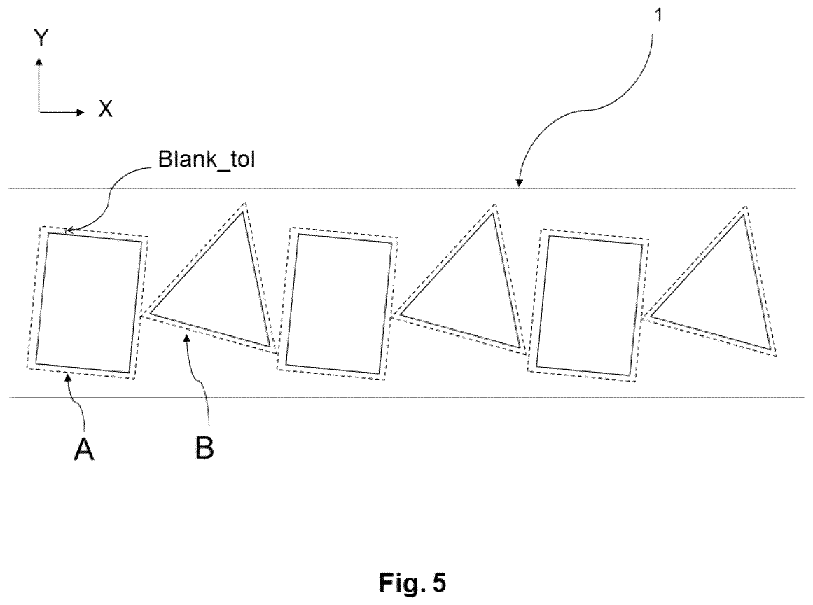

In a particular embodiment, the width of the coil W takes into account a width tolerance W_tol, usually expressed in mm. This in turn affects the width value W used in calculating the scrap cost and the blanking cost. Said width tolerance corresponds for example to the precision that the strip production line can achieve in terms of width. In order to guarantee that blanks A and B will fit into the strip even when the width of the manufactured strip is at the lower end of the width tolerance spectrum, it will be necessary to aim for a strip width W corresponding at least to the minimum width necessary to fit in blank A and blank B within said strip to which the width tolerance W_tol is added. This configuration is illustrated on FIG. 5, where a margin of W_tol/2 is left on either side of the strip 1.

In a particular embodiment, a blanking tolerance Blank_tol, usually expressed in mm, is taken into account when nesting blanks A and B in the strip and thus also when calculating the scrap ratio and the material usage. Said blanking tolerance corresponds to the precision of the tool used to cut out the blanks in the strip. In order to guarantee that there is no overlap between the blanks when cutting them out of the strip, the distance between two neighboring blanks should not be below 2*Blank_tol (indeed each blank is cut out with a precision of Blank_tol and only by providing for a distance between two neighboring blanks taking into account the blanking tolerance of each individual blank can the risk of overlap be fully avoided). This is also illustrated in FIG. 5.

In a particular embodiment, such as illustrated on FIG. 6, a blanking tolerance is taken into account in the above described cost optimization methods. This is done by first geometrically inflating blanks A and B by a factor of Blank_tol before applying the blank nesting method.

In a particular embodiment, the above described methods are applied to a configuration wherein blank B has exactly the same contour as blank A. This is a very common case in which there is in fact only one blank shape to be cut out from a strip 1. In a particular embodiment in which blank contour A=blank contour B, the direction of A and B relative to the longitudinal direction is the same in the above described optimization methods. In other words, the problem space only contains [α, β, dy] points for which α=β or α=β+180° mod 360° (mod denoting the modulo operator). This corresponds for example to a situation in which the direction of the blank within the strip has a technical impact on the subsequent processes—for example in the case of steel, when the material is anisotropic and thus will behave differently if cut out at different angles towards the longitudinal direction. For example, this is the case when processing by stamping steel blanks from a strip having anisotropic properties. This allows to have the same behavior in the subsequent processes of blanks A and B. This also allows for a smaller number of points in the problem space and thus more rapid cost optimization.

In a particular embodiment, the above described methods are applied to a configuration wherein blank A and B have the same contours and in which dy=0, i.e. the problem space only consists of two dimensions corresponding to the angles α and β.

In a particular embodiment, the above described methods are applied to a configuration wherein blank A and B have the same contours, dy=0 and α=β, i.e. the problem space only consists of one dimension corresponding to the angle α.

In a particular embodiment, the above described methods are applied to a configuration wherein blank B is a mirror image contour of blank A. This is a very common case for example in the automotive industry in which many parts are present on both sides of the vehicle as a right hand and left hand part, which are generally mirror images of one another.

What is claimed is:

1-20. (canceled)

21: A computer implemented method for a nesting of two blanks A and B within a rectangular strip, the strip extending in a longitudinal direction X and having a transverse direction Y, the method comprising the following steps:
step 1.1 providing 2-dimensional blank contours defining blank contour A and blank contour B;
step 1.3 computing a value of a quantity Material(α, β, dy) for several values of a, R and dy to determine a minimum value, MinMaterial, of the quantity Material(α, β, dy), Material(α, β, dy) corresponding to a material usage obtained when nesting blank contour A and blank contour B in the rectangular strip, blank contour A being oriented with an angle α, blank contour B being oriented with an angle β and dy being a difference in transversal elevation between a lowest point of blank A and a lowest point of blank B, a minimum value of Material(α, β, dy);
step 1.4 outputting to a user the minimum value of Material(α, β, dy), noted MinMaterial, and values αₒₚₜᵢₘₐₗ, βₒₚₜᵢₘₐₗ, dyₒₚₜᵢₘₐₗ, wherein Material(αₒₚₜᵢₘₐₗ, βₒₚₜᵢₘₐₗ, dyₒₚₜᵢₘₐₗ) equals MinMaterial; and
step 1.5 positioning in the strip a first blank A with an angle αₒₚₜᵢₘₐₗ, a first blank B with an angle βₒₚₜᵢₘₐₗ and a transverse offset dyₒₚₜᵢₘₐₗ, a following blank A with the angle αₒₚₜᵢₘₐₗ and in transverse alignment of the first blank A and a following blank B with the angle βₒₚₜᵢₘₐₗ and the transverse offset dyₒₚₜᵢₘₐₗ and repeating the pattern along the strip.

22: The computer implemented method according to claim 21 further including: step 1.2 providing a function Material(α, β, dy) returning the value of the quantity Material(α, β, dy), given the values of α, β and dy.

23: The computer implemented method according to claim 21 wherein, given a desired angular accuracy ε_{angle} expressed in angular degrees and a desired distance accuracy ε_{dy} expressed in mm, blank A having a maximum height in the transverse direction dymax, step 1.3 is executed by computing a minimum material usage value MinMaterial as being the minimum value of all Material(α, β, dy) values over all the combinations of (ε_{angle}*i, ε_{angle}*j, ε_{dy}*k), where i, j and k are integers comprised between 0 and respectively 360/ε_{angle}+1, 360/ε_{angle}+1 and dymax/ε_{dy}+1.

24: The computer implemented method according to claim 21 wherein in step 1.5 the pattern is repeated along the strip as far as it extends longitudinally.

25: The computer implemented method according to claim 21 wherein the quantity Material(α, β, dy) corresponds to a material usage obtained for an optimal longitudinal spacing (Δ₁, Δ₂) between blank A and blank B, the optimal longitudinal spacing minimizing the material usage given the fixed value of α, of β, and of dy.

26: The computer implemented method according to claim 21 wherein step 1.3 is accelerated using an accelerated method according to which several iterations of Material(α, β, dy) calculations are performed, each iteration being carried on a limited number of possible (α, β, dy) combinations, and, at each iteration, (α, β, dy) combinations having the lowest material usages are selected and each subsequent iteration is performed using neighboring points of the selected points, in the (α, β, dy) space.

27: The computer implemented method according to claim 26 wherein the accelerated method includes the following steps:
step 2.1 selecting the (α, β, dy) combinations having the lowest Material(α, β, dy) values out of only part of the possible combinations (α, β, dy) of step 1.3 according to claim 21;
step 2.2 repeating the following iteration for k=1 to N-1, wherein N is an integer equal to or greater than 2, selecting the (α, β, dy) combinations having the lowest Material(α, β, dy) values out of the (α, β, dy) combinations selected at the previous step and at least part of their neighboring (α, β, dy) combinations, wherein a neighboring combination to (α, β, dy) is the combination (α+X*uₖ*ε_{angle}, β+Y*vₖ*ε_{angle}, dy+Z*wₖ*ε_{dy}), wherein X, Y and Z can each take on the values −1, 0 or +1, wherein uₖ, vₖ and wₖ are integers equal to or greater than 2 and wherein uₖ<uₖ₋₁, vₖ<vₖ₋₁ and wₖ<wₖ₋₁;
step 2.3 determining an accelerated minimum material usage MinMaterialAcc as being the minimum value of Material(α, β, dy) out of the (α, β, dy) combinations selected at the previous step and at least part of their neighboring (α, β, dy) combinations (α+X*u_{N}*ε_{angle}, β+Y*v_{N}*ε_{angle}, dy+Z*w_{N}*ε_{dy}), wherein X, Y and Z can each take on the values −1, 0 or +1, wherein u_{N}, v_{N} and w_{N} are integers equal to or greater than 1 and wherein u_{N}<u_{N-1}, v_{N}<v_{N-1} and w_{N}<w_{N-1}; and
step 2.4 outputting to a user the accelerated minimum material usage MinMaterialAcc and the values α_{optimal_acc}, β_{optimal_acc}, dy_{optimal_acc}, wherein Material(α_{optimal_acc}, β_{optimal_acc}, dy_{optimal_acc}) equals MinMaterialAcc.

28: The computer implemented method according to claim 27 wherein the possible (α, β, dy) combinations of step 2.1 are (ε_{angle}*C*i, ε_{angle}*D*j, ε_{dy}*E*m) combinations wherein C, D and E are fixed integers strictly greater than 1 and wherein i, j and m are integers taking on all the integer values between 0 and respectively 360/(ε_{angle}*C)+1, 360/(ε_{angle}*D)+1 and dymax/(ε_{dy}*E)+1.

29: The computer implemented method according to claim 27 further including an initial step of providing a tolerance threshold T % strictly greater than 0% and strictly smaller than 100% and wherein the selection process of iterative step 2.2 is performed by selecting the (α, β, dy) combinations having the T % lowest Material(α, β, dy) value out of the (α, β, dy) combinations selected at the previous step and at least part of their neighboring (α, β, dy) combinations.

30: The computer implemented method according to claim 27 wherein the iterative step 2.2 is defined as uₖ=uₖ₋₁/2, vₖ=vₖ₋₁/2 and wₖ=wₖ₋₁/2.

31: The computer implemented method according to claim 27 wherein steps 2.2 and 2.3 are further characterized by the fact that all the neighboring (α, β, dy) combinations of the (α, β, dy) combination selected during the previous step are used, wherein all combinations (α+X*uₖ*ε_{angle}, β+Y*vₖ*ε_{angle}, dy+Z*wₖ*ε_{dy}), and wherein X, Y and Z take on all of the values −1, 0 and +1 are used at steps 2.2 and 2.3.

32: The computer implemented method according to claim 27 wherein u_{N}=1, v_{N}=1 and w_{N}=1.

33: The computer implemented method according to claim 27 wherein ε_{angle}=1°, ε_{dy}=1 mm, N=5 and T %=1%.

34: The computer implemented method according to claim 21 further including:
an initial step of providing a blanking tolerance Blank_tol;
in between steps 1.1 and 1.2 of claim 21 a step of geometrically inflating blanks A and B by a factor of Blank_tol; and
then applying the subsequent steps to the resulting inflated blank contours of blank A and blank B.

35: The computer implemented method according to claim 25 including, given the value of α, of β, and of dy,
determining the optimal longitudinal spacing (Δ₁, Δ₂) between blank A and blank B, by
providing a X, Y coordinate system parallel to L, T, where blank A is positioned in the X, Y coordinate system so that a furthest left point of blank A is located at X=0 and a lowest point of blank A is located at Y=0 and blank B is positioned that a furthest left point of blank B is located at X=0 and a lowest point of blank B is located at Y=dy;
providing a numerical representation of the contours of blank A and blank B in the X, Y coordinate system consisting of discrete sets of vertices {A₁, . . . , A_{P}} and {B₁, . . . B_{q}}, p and q being integers greater than or equal to 3, the vertices being joined by straight edges;
computing for each vertex Aᵢ a distance dAᵢA being defined as a difference between a largest X value taken by the contour of blank A and the a X value taken by the contour of blank A at the Y value of vertex Aᵢ and calculating a largest inner transverse distance dAA defined as a maximum value of all dAᵢA;
computing for each vertex Bᵢ the distance dBᵢB being defined as the difference between a largest X value taken by the contour of blank B and a smallest X value taken by the contour of blank B at the Y value of vertex Bᵢ and calculating a largest inner transverse distance dBB defined as a maximum value of all dBᵢB;
computing for each vertex Aᵢ located at a Y value for which at least one point of the contour of blank B is present oriented distances dAᵢB and dBAᵢ defined respectively as a difference between the largest X value taken by the contour of blank B and a smallest X value taken by the contour of blank A at the Y value of vertex Aᵢ and as a difference between the largest X value taken by the contour of blank A and the smallest X value taken by the contour of blank B at the Y value of vertex Aᵢ;
computing for each vertex Bᵢ located at a Y value for which at least one point of the contour of blank A is present oriented distances dABᵢ and dBᵢA defined respectively as a difference between the largest X value taken by the contour of blank B and the smallest X value taken by the contour of blank A at the Y value of vertex Bᵢ and as the difference between the largest X value taken by the contour of blank A and the smallest X value taken by the contour of blank B at the Y value of vertex Bᵢ;
computing an oriented distance dAB defined as a maximum value of all dAᵢB and dAB₁ values, and computing an oriented distance dBA defined as the maximum value of all dBᵢA and dBA₁ values;
Δ₁ being defined as a pitch in the longitudinal direction between a left extremity of an A blank and a left extremity of its right-hand neighboring B blank, setting Δ₁ to the value dBA; and
Δ₂ being defined as a pitch between the a extremity of a B blank and a left extremity of its right-hand neighboring A blank, setting Δ₂ to dBA if dAB+dBA≥dAA and dAB+dBA≥dBB, setting Δ₂ to dAA−dBA if dAB+dBA<dAA and dAA≥dBB, setting Δ₂ to dBB−dBA if dAB+dBA<dBB and dBB>dAA.

36: The computer implemented method according to claim 21 wherein blank B has the identical contour as blank A.

37: The computer implemented method according to claim 36 wherein dy=0 and α=β.

38: The computer implemented method according to claim 21 wherein blank B has a mirror image contour of blank A.

39: A computer program comprising instructions for a computer to carry out the computer implemented method according to claim 21.

40: A computer-readable storage medium comprising instructions for a computer to carry out the computer implemented method according to claim 21.

41: A blanking method comprising: performing the method as recited in claim 21 and subsequently blanking blank A and blank B from the strip.
